(19) United States
(12) Patent Application Publication
(10) Pub. No.: US 2004/0150649 A1
(43) Pub. Date: Aug. 5, 2004

(54) Method and apparatus for matching multiple displays in a multi-display environment

(76) Inventor: Jerry Moscovitch, Toronto (CA)

Correspondence Address: John B. Hardaway, III, Nexsen Pruet Jacobs & Pollard, LLC, P.O. Box 10107, Greenville, SC, 29603, US

(21) Appl. No.: 10/354,867

(22) Filed: Jan. 30, 2003

(51) Int. Cl. G09G 5/02

(52) U.S. Cl. 345/589

(57) ABSTRACT

A method and apparatus for matching at least one visual parameter of multiple displays in a multi-display system environment, the method includes the steps of (a) selecting a visual parameter to be matched; (b) measuring a value associated with the visual parameter in step (a) for a reference display and establishing a reference value; (c) measuring a value associated with the visual parameter in step (a) for another display in the multi-display and establishing a comparative value; (d) comparing the comparative value from step (c) with the reference value from step (b); (e) adjusting the comparative value for the display in step (c) to match the reference value from step (b); and, (f) repeating steps (c)-(e) for any additional displays.

### FIELD OF THE INVENTION

This invention relates to multiple displays in a multi-display system environment, generally. In particular, this invention relates to a method and apparatus for matching multiple displays in a multi-display system environment.

### BACKGROUND OF THE INVENTION

The number of multi-display or multi-screen computer systems has increased in recent years as computer users in various industries adapt their use to new environments. For example, a multi-display system can be used to create the illusion of a larger screen, thereby allowing a securities trader to view a large single spreadsheet over several displays. Alternately, the trader may view individual applications on individual screens (for example, one screen may display a Web Browser, a second a new service and a third a spreadsheet of financial data).

Individuals working with still or moving images, such as graphics artists, video or film editors or medical diagnosticians may also use multi-display systems. A given image may be viewed across several screens or two images may be viewed side-by-side (such as two x-ray images used to assess the extent to which a broken bone has healed).

Although the potential uses for multi-display systems appear to be limited only by the user's imagination, there are barriers to their accepted widespread use. A significant barrier is the fact that although individual displays may be manufactured by identical processes using materials that conform to the given manufacturer's specifications there still are minor variations in manufacturing materials that might result in any two monitors presenting slightly different images to a user, even if the displays have identical display settings. For example, when two displays that are set to the same brightness level are viewed, one display might and often does appear brighter than the other. The potential consequences of these differences range from the merely annoying, to the potentially disastrous depending on the application. For example an individual view in a large spreadsheet or chart over several screens may find that minor color and brightness variations destroy the illusion of continuity between the screens and ultimately of the chart. A medical diagnostician, however, may find that these variations make it more difficult to assess the degree to which a broken bone has healed. This may result in the diagnostician recommending an unnecessary and potentially harmful course of treatment.

Although an individual may manually adjust some display parameters, the ultimate success or failure of any such adjustments rests with the individual's ability to perceive and eliminate these differences. Perception, especially color perception, varies significantly between individuals. As such, manual adjustments based on an individual's perceptions are largely imprecise and time-consuming activities that might not result in the desired end. There remains a need to quickly and precisely match displays in a multi-display system.

### SUMMARY OF THE INVENTION

The present invention provides a method for matching at least one visual parameter of multiple displays in a multi-display system environment, the method includes the steps of (a) selecting a visual parameter to be matched; (b) measuring a value associated with the visual parameter in step (a) for a reference display and establishing a reference value; (c) measuring a value associated with the visual parameter in step (a) for another display in the multi-display and establishing a comparative value; (d) comparing the comparative value from step (c) with the reference value from step (b); (e) adjusting the comparative value for the display in step (c) to match the reference value from step (b); and, (f) repeating steps (c)-(e) for any additional displays.

The measured value is that of the visual parameter as it is presented to a user (i.e., presented value), which has a corresponding setting value that determines the value of the presented value. The presented value is adjusted by adjusting the setting value of the selected visual parameter. The visual parameter may be luminance, color, contrast or combinations thereof.

The presented value may be user-defined or pre-defined.

The present invention also provides an apparatus for matching at least one visual parameter of multiple displays in a multi-display system environment, which includes a sensor, that is moveable between displays in a multi-display system to detect and measure a value associated with a visual parameter of a reference display and at least one additional display; a memory communicating with the sensor for receiving and storing the measured value of the reference display as a reference value; a comparer communicating with the memory and the sensor for receiving the measured value of the additional display, comparing it to the corresponding stored reference value and generating an adjustment factor; and, an adjuster in communication with the additional display for receiving the adjustment factor and adjusting the value of the compared visual parameter to match the reference value.

The visual parameter detected by the sensor may be luminance, color or combinations thereof.

The adjustment factor is a measure of the difference between the presented value of the reference display and the presented value of the additional display.

### BRIEF DESCRIPTION OF THE DRAWINGS

Preferred embodiments of the present invention are described below with reference to the accompanying drawings in which:

FIG. 1 is a schematic view illustrating a system for matching multiple displays in a multi-display environment according to the present invention;

FIG. 2 is a schematic plan view of a display according to the present invention;

FIG. 3a is a schematic plan view of a sensor displaying a first alternate sensor anchoring means according to the present invention;

FIG. 3b is a schematic plan view of a sensor displaying a second alternate sensor anchoring means according to the present invention; and,

FIG. 4 is a flow chart view illustrating the steps in a method for matching multiple displays in a multi-display environment according to the present invention.

### DETAILED DESCRIPTION OF THE INVENTION

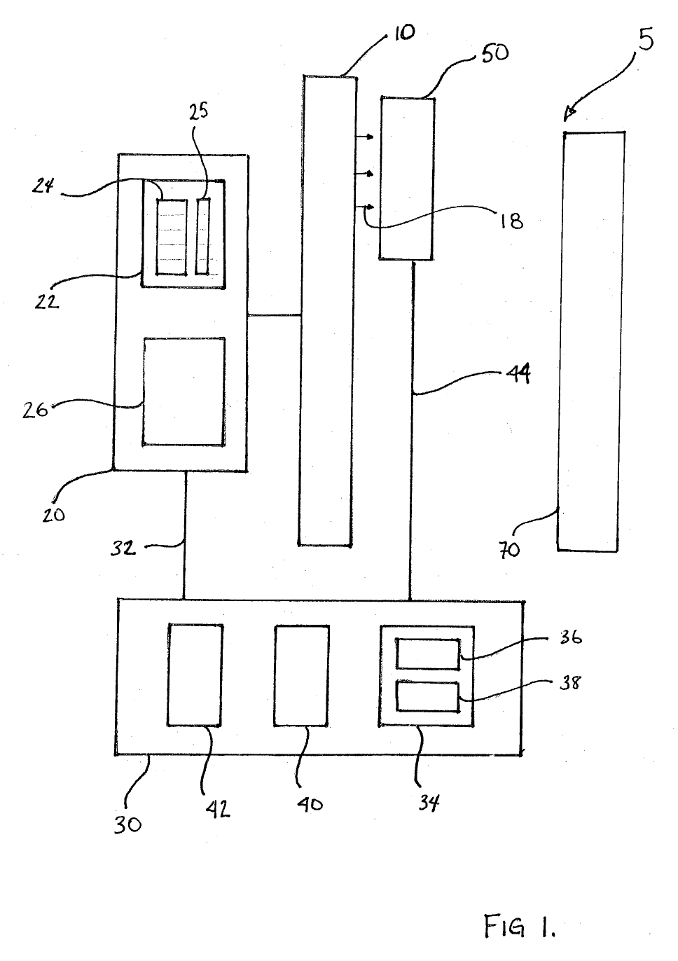

FIG. 1 illustrates a System generally indicated by reference 5 in accordance with a preferred embodiment of the invention.

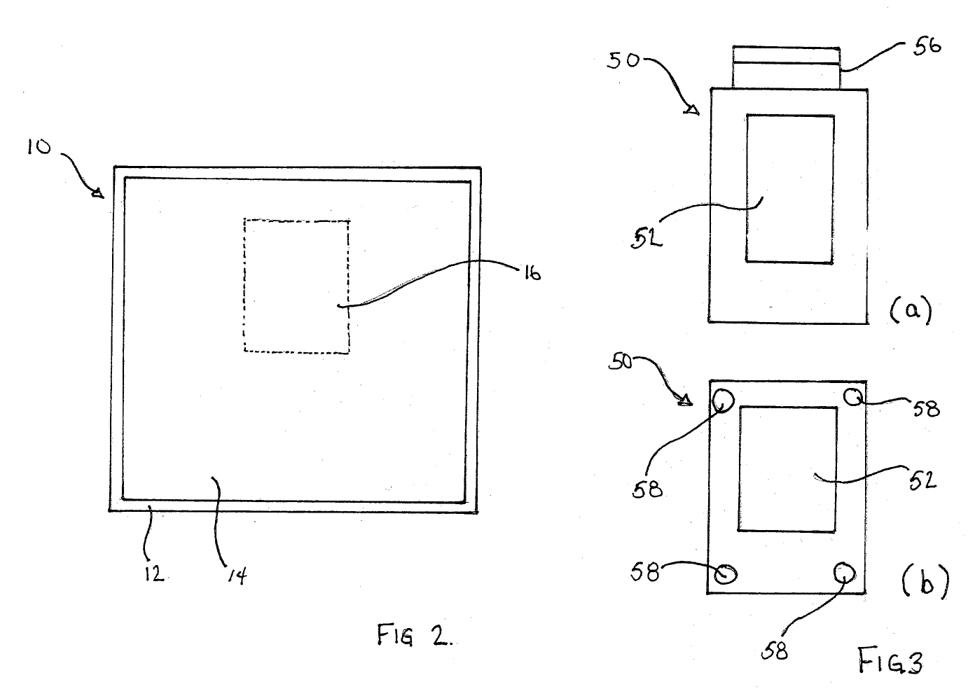

Referring to FIGS. 1, 2 and 3, the System 5 is a system for matching multiple displays in a multi-display system environment comprising a reference monitor or display 10, a monitor or display controller 20, a sensor 50, a sensor controller 30 and at least one additional monitor or display 70. The monitor 10 is preferably an LCD monitor of the type known to those in the art, such as the Model LM181E06, manufactured by L. G. Phillips LCD of Korea, although any other display known to those in the art may be used. The monitor 10 has a housing 12 surrounding a display area 14. A portion of the display area 14, identified as sensing and measuring area 16, is the portion of the display that is sampled during the matching process.

The quality of the images displayed on the display area 14 is controlled by a display controller 20, which includes at least one Look-Up or Parameter Table 22 and a receiver/writer 26. The Look-Up Table 22 stores a set of visual parameters 24 that define the quality of the displayed images. The visual parameters 24 typically include luminance, contrast and color temperature. Each visual parameter 24 has two corresponding values. The first value is a presented value 18; i.e., the visual parameter 24 as it is presented to a system user. The presented value 18 has a corresponding setting value 25, which largely determines the value of the presented value 18. The setting value 25 for each visual parameter 24 is stored in the Look Up Table 22 of the display controller 20. Accordingly, the presented value 18 is adjusted by adjusting the setting value 25. The presented value 18 is also affected by other factors, such as the quality and physical properties of the display construction materials, for example, slight variations in the conductance properties of the monitor construction materials. As a result, if two displays are set to identical setting values 25, but are constructed of materials with slightly different physical properties, then the quality of the image presented to a user of a multi-display system will vary between monitors; i.e., each monitor will have identical setting values 25, but different presented values 18.

Although a user is able to identify qualitative differences between any two monitors, those differences cannot be readily quantified or resolved without the use of an instrument such as the sensor 50, which is moveable between displays in a multi-display system and configured to detect and measure the presented value 18 associated with a visual parameter 24 of the reference display 10 and at least one additional display 70. The sensor 50 includes a lens or detecting array 52, which detects and quantifies the presented value 18 of any given visual parameter 24 for which it was configured to detect. The sensor 50 is placed over the measuring area 16 of the display 10, with the detecting array 52 facing the measuring area 16.

The sensor 50 may be releasably secured to the display 10 by any releasable securing means known to those in the art, such as a clip 56, which attaches to the display housing 12. Alternately, the sensor 50 may be secured by using suction cups 58, which attach to the display area 14. Any other attachment means for releasably securing the sensor to the display known to those in the art may be employed.

The sensor 50 may be a sensor of the type known to those in the art, such as the SPYDER, manufactured by ColorVision of Rochester, N.Y., U.S.A. Alternately, any means for sensing, moveable between displays in a multi-display system, for detecting and measuring a value associated with a visual parameter of a reference display and at least one additional display may be employed.

The sensor 50 is controlled by a sensor controller 30, which includes a memory 34 for storing the presented visual parameter values as detected and measured by the sensor 50. The memory 34 communicates with the sensor 50 and receives and stores the measured value of the reference display as a reference value.

The memory 34 is a non-volatile computer readable memory of the type known to those in the art. The measured values that memory 34 stores include a reference value 36 and a comparative value 38. The reference value 36 is the standard presented value 18 for any given visual parameter 24 against which all comparative values 38 are measured. Alternately, any means for storing the measured value of the reference display as a reference value may be employed.

The reference value 36 may be user-defined or pre-defined. For example, if color is the selected visual parameter, then a color reference used may be that as defined by the International Color Consortium (Specification ICC.1:2001-12; http://www.color.org).

The comparer 40 communicates with the memory 34 and the sensor 50 for receiving the measured value of the additional display 38, comparing it to the corresponding stored reference value 36 and generating an adjustment factor. Sensor controller 30 also includes a comparer 40, which compares the stored reference value 36 to its corresponding comparative value 38 and generates an adjustment factor by which the visual parameter's setting value should be adjusted so that the comparative presented visual parameter 38 is substantially identical to the stored reference value 36. The adjustment factor is a measure of the difference between the presented value of the reference display and the presented value of the additional display.

The comparer 40 may be a sub-routine of the matching system, or a stand-alone application that interacts with the sensor 50, memory 34 and adjuster 42. Alternately, any means for comparing the measured value of the additional display to the corresponding stored reference value and generating an adjustment factor known to those skilled in the art may be employed.

The adjustment factor is taken by an adjuster 42, which in turn transmits the adjustment factor to receiver/writer 26 of the display controller 20 via communication link 32. Receiver/writer 26 then adjusts the setting value 25 of the Look Up Table 22 so that the corresponding presented value 18 matches the reference value 36 for the given visual parameter 24. The adjuster 42 may be a sub-routine of the matching system, or a stand-alone application that interacts with the display controller 20 and comparer 40. The adjuster 42 communicates with the additional display for receiving the adjustment factor and adjusting the value of the compared visual parameter 38 to match the reference value 36. Alternately, any means for adjusting the value of the compared visual parameter to match the reference value may be employed.

The sensor 50, memory 34, comparer 40 and adjuster 42 together comprise an apparatus for matching at least one visual parameter of multiple displays in a multi-display system environment. In a preferred embodiment, the apparatus is housed in a single unit. In an alternate embodiment, the components of the apparatus are distributed throughout the multi-display system environment.

Method of Matching:

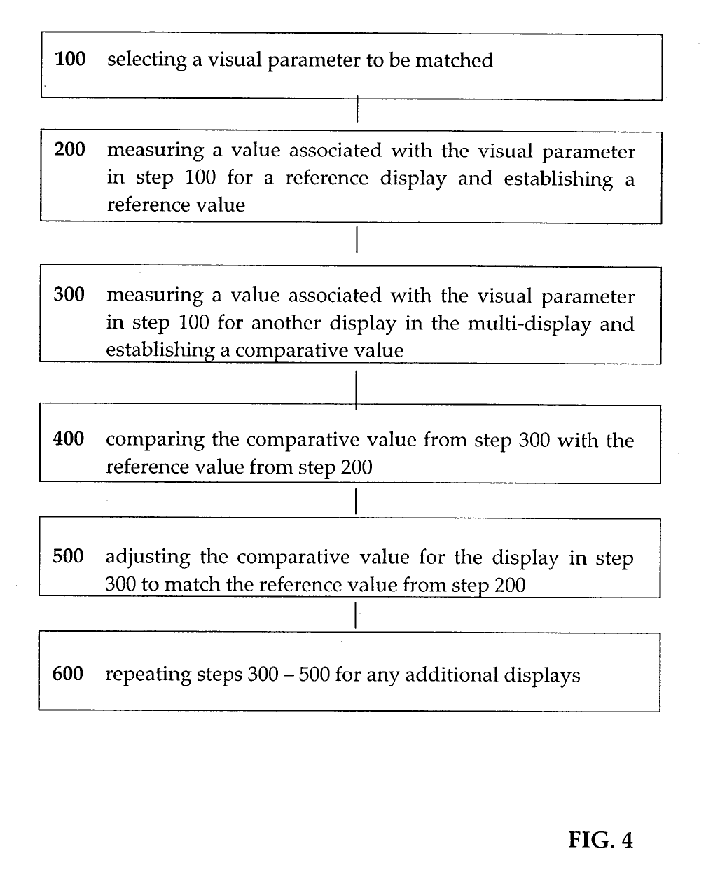

A method of matching at least one visual parameter of multiple displays in a multi-display system environment according to one embodiment of the present invention will now be discussed with reference to FIGS. 1 and 4. Beginning at step 100, a visual parameter to be matched is selected. The visual parameter may be luminance, contrast, color or combinations thereof. Once the visual parameter or combination of visual parameters is selected, then at step 200 a presented value 18 associated with the visual parameter selected in step 100 is selected as a reference value 36.

In a preferred embodiment, a user using the sensor controller 30 invokes an on-screen display menu and selects a calibrate sub-menu. A test signal is generated and the user is prompted to place the sensor 50 over the sensing area 16 of the display 10. The sensor 50 communicates with the sensor controller 30 via sensor communication link 44, which may be either a wired or wireless connection. The sensor controller in turn communicates with display controller 20 via display communication link 32, which may also be a wired or wireless connection. The user is then prompted to calibrate the display 10 visual parameters. This may be done automatically or manually through either a pre-defined or user-defined set of visual parameter values. When the calibration is complete, the display's 10 visual parameter profile is stored in the memory 34 as reference value 36. The setting values 25 of Look Up Table 22 are also updated by receiver/writer 26 in the display controller 20 to reproduce the reference visual parameter profile. The memory 34 may store any number of reference values 36 and reference visual parameters as is required by the user's system needs.

At step 300, a presented value 18 associated with the visual parameter 24 selected in step 100 is measured for another display 70 in the multi-display environment and a comparative value 38 is generated. In a preferred embodiment, to match the visual parameter profiles of an additional display 70 to the reference visual parameter profile, a user using the sensor controller 30 invokes an on-screen display and selects a Match sub-menu. A test signal is generated and the user is prompted to place the sensor 50 over a sensing area of the additional display 70. The sensor 50 communicates with the sensor controller 30 via sensor communication link 44 and transmits the additional display visual parameter profile to the memory 34 as comparative value 38.

At step 400, a comparer 40 compares the comparative value 38 with the reference value 36 and an adjustment factor is generated. Once the adjustment factor is generated, the adjuster 42 communicates with the receiver/writer 26 of display controller 20 via communication link 32 to adjust the setting value 25 of the selected visual parameter 24 such that its presented value 18 matches the reference value 36 for the given visual parameter. At step 600, steps 300 to 500 are repeated for any additional displays in the multi-display system.

In an alternate embodiment step 200 includes the additional steps of selecting a presented value 18 to which the visual parameter 24 in step 100 is to be set; and, adjusting the setting value 25 of the visual parameter 24 of the reference display 10 so that the selected presented value 18 is presented.

In a further alternate embodiment step 500 includes the additional steps of adjusting the setting value 25 of the additional display 70 so that its presented value matches the presented value 18 of the reference display 10.

In an alternate embodiment, the reference value 36 of memory 34 may be stored in other memory stores, such as a centrally located network memory store 80, as central reference value 82. The central reference value 82 may then be accessed by any remote multi-display system and stored in the local memory of each system. The presented values of the remote multi-display systems may then be matched to the central reference value 82. In an alternate embodiment, the reference values 36 are incorporated into a network user's network profile as a profile reference value 84. As the network user logs on, to any given multi-display system in a networked environment, the given multi-display system's presented values will be matched to the profile reference value 84 included in the user's profile.

In a further alternate embodiment, sensor 50 and sensor controller 30, which includes the memory 34 and the reference values 36, are physically moved from system 5 and incorporated into a remote multi-display system. Once incorporated, the remote multi-display system presented values may be matched to the reference value 36

The present invention is defined by the claims appended hereto, with the foregoing description being illustrative of the preferred embodiments of the invention. Those of ordinary skill may envisage certain additions, deletions and/or modifications to the described embodiments, which, although not explicitly suggested herein, do not depart from the scope of the invention, as defined by the appended claims.

What is claimed is:

1. A method for matching at least one visual parameter of multiple displays in a multi-display system environment, including the steps of:
(a) selecting a visual parameter to be matched;
(b) measuring a value associated with the visual parameter in step (a) for a reference display and establishing a reference value;
(c) measuring a value associated with the visual parameter in step (a) for another display in the multi-display and establishing a comparative value;
(d) comparing the comparative value from step (c) with the reference value from step (b);
(e) adjusting the comparative value for the display in step (c) to match the reference value from step (b); and,
(f) repeating steps (c)-(e) for any additional displays.

2. The method of claim 1, wherein the measured value of steps (b) and (c) is that of the visual parameter as it is presented to a user and the presented value has a corresponding setting value, which determines the value of the presented value.

3. The method of claim 2, wherein the presented value is adjusted by adjusting the setting value of the selected visual parameter.

4. The method of claim 3, wherein step (b) includes the additional steps of:
(b-i) selecting a presented value to which the visual parameter in step (a) is to be set; and,
(b-ii) adjusting the setting value of the visual parameter of the reference display so that the selected presented value is presented.

5. The method of claim 3, wherein step (e) includes the additional steps of adjusting the setting value of the other display so that its presented value matches the presented value of the reference display.

6. The method of claim 2, wherein the presented value is user-defined.

7. The method of claim 2, wherein the presented value is pre-defined.

8. The method of claim 1, wherein the display is an LCD monitor.

9. The method of claim 1, wherein the visual parameter is a member selected from the group consisting of luminance, contrast, color and combinations thereof.

10. The method of claim 1, wherein the measured value of steps (b) and (c) is measured using a sensor configured to detect and quantify the selected visual parameter.

11. The method of claim 9, wherein the measured value of steps (b) and (c) is stored in a non-volatile computer readable memory.

12. The method of claim 11, wherein the non-volatile computer readable memory is located at a location remote from the sensor.

13. The method of claim 2, wherein the setting value is stored in a display controller.

14. An apparatus for matching at least one visual parameter of multiple displays in a multi-display system environment, including:
a. a sensor, moveable between displays in a multi-display system to detect and measure a value associated with a visual parameter of a reference display and at least one additional display;
b. a memory communicating with the sensor for receiving and storing the measured value of the reference display as a reference value;
c. a comparer communicating with the memory and the sensor for receiving the measured value of the additional display, comparing it to the corresponding stored reference value and generating an adjustment factor; and,
d. an adjuster in communication with the additional display for receiving the adjustment factor and adjusting the value of the compared visual parameter to match the reference value.

15. The apparatus of claim 14, wherein the visual parameter is a member selected from the group consisting of luminance, contrast, color and combinations thereof.

16. The apparatus of claim 14, wherein the sensor further includes an attachment means for releasably securing the sensor to the display.

17. The apparatus of claim 14, wherein the measured value is that of the visual parameter as it is presented to a user and the presented value has a corresponding setting value, which determines the value of the presented value.

18. The apparatus of claim 17, wherein the presented value is adjusted by adjusting the setting value of the selected visual parameter.

19. The apparatus of claim 18, wherein the setting value is stored in a memory of a display controller.

20. The apparatus of claim 19, wherein the adjuster adjusts the setting value of the additional display.

21. The apparatus of claim 14, wherein the memory is a non-volatile computer readable memory.

22. The apparatus of claim 14, wherein the non-volatile computer readable memory is located at a location remote from the sensor.

23. The apparatus of claim 14, wherein the adjustment factor is a measure of the difference between the presented value of the reference display and the presented value of the additional display.

24. An apparatus for matching at least one visual parameter of multiple displays in a multi-display system environment, including:
a. a means for sensing, moveable between displays in a multi-display system, for detecting and measuring a value associated with a visual parameter of a reference display and at least one additional display;
b. a means for storing the measured value of the reference display as a reference value;
c. a means for comparing the measured value of the additional display to the corresponding stored reference value and generating an adjustment factor; and,
d. a means for adjusting the value of the compared visual parameter to match the reference value.
